(19) United States
(12) Patent Application Publication
(10) Pub. No.: US 2009/0216517 A1
(43) Pub. Date: Aug. 27, 2009

(54) DEDICATED SIMULATOR FOR TESTING A USB HOST SOLUTION

(76) Inventors: OPHIR HERBST, Haifa (IL); Ilya Lifshits, Netanya (IL); Boris Dinkevich, Rishon Lezion (IL)

Correspondence Address: DANIEL J SWIRSKY, 55 REUVEN ST., BEIT SHEMESH, 99544, IL

(21) Appl. No.: 12/363,767

(22) Filed: Feb. 1, 2009

Related U.S. Application Data
(60) Provisional application No. 61/064,292, filed on Feb. 27, 2008.

(51) Int. Cl. G06F 9/00; G06F 17/30

(52) U.S. Cl. 703/21; 707/100; 710/305; 707/E17.044

(57) ABSTRACT

An apparatus, system and method for testing USB host solutions, which provide for interactions with simulated USB devices according to the USB specification and also the behavior of actual USB devices as determined in a working environment.

### CROSS-REFERENCE TO RELATED APPLICATIONS

This application claims priority from U.S. Provisional Patent Application No. 61/064,292, filed Feb. 27, 2008, entitled “Dedicated simulator for testing a USB host solution”, the disclosure of which is hereby incorporated by reference.

### FIELD OF THE INVENTION

The present invention is of an apparatus, system and method for testing a USB host solution, and in particular, of such an apparatus, system and method which includes preferably hardware and a plurality of executable instructions for simulating a plurality of USB devices.

### BACKGROUND OF THE INVENTION

The standards for USB (Universal Serial Bus) are developed and maintained by the USBIF (Universal Serial Bus Implementers Forum), a non-profit corporation. USB itself relates to a standardized plug and port combination, intended to ensure that peripherals and other devices by different manufacturers which interact with computers would be compatible. Any USB compatible device can communicate with a computer through a USB port, for example for a computer keyboard or mouse.

On the physical side, the USB specification specifies the size and shape of the connectors, and also how the connectors interact with the port, thereby ensuring compatibility between the “plug” of the USB compatible device or its cable, and the receiving port of the host computer.

With regard to the logical side of the USB specification, it provides a control structure in which a host communicates with one or more USB compatible devices. Communication occurs through pipes or logical channels from the USB host solution to a logical entity on the USB compatible device itself, known as an endpoint. If a USB compatible device has multiple endpoints, they are grouped into interfaces. Communication over the bus is controlled by the host software using the USB host solution, which polls the endpoints to determine whether each has data to transfer.

Designing and implementing a USB host solution is not trivial. Therefore, testing of such USB host solutions is essential. The best type of testing closely simulates the actual working environment of the device, including simulated inputs and measurement of the outputs, to determine whether the host solution would actually function as expected when in use.

Various solutions have been proposed to for testing of host controllers, hubs and other USB host hardware. For example, U.S. Pat. No. 7,225,288 proposes an actual test circuit, which includes an enhanced host controller for high speed USB traffic, a companion host controller for low speed USB traffic and USB transceiver macrocell that is connected to the enhanced host controller to handle the data transfer to and from a USB device. The enhanced host controller comprises a test circuit for controlling the USB transceiver macrocell to perform full-speed and/or low-speed test functions, such that traffic is fed into or received from the macrocell and is then handled by the USB host controller. However, the described test circuit is targeted for testing USB hardware and does not provide a full software testing capability, and is also very limited in terms of the tests which may be performed.

Another approach, provided by a Lecroy Device Simulator, involves the use of a USBTrainer module, which transmits valid and invalid traffic over standard USB cables. Users create test patterns by exporting any traffic stream from a previously recorded USBTracer trace. These stimulus files can be played back bit-for-bit using LeCroy's USBTrainer module. This allows validation engineers to easily recreate problems reported in the field using a simple trace file. Also, users can attempt to create “errors” in data traffic in order to test the response by the USB host solution. However, again this approach suffers from drawbacks. In particular, it may be useful to solve a problem once it has been identified in the field, but cannot detect such a problem before it occurs in the field. Users may attempt to guess at which problems may occur in the field, but cannot do so with any certainty that the guessed problems would actually occur in the “real” environment and cannot in advance anticipate possible error conditions that exist in the real world.

Other suggested testing approaches include the Ellisys USB Explorer 260, which can emulate the USB Host and/or USB devices for testing. It can also inject pre-defined error patterns for stress and error recovery testing. However, again this approach suffers from drawbacks, as errors may occur beyond those that are predefined by the engineers. Also, emulations do not necessarily provide a true “real world” interactive device, as the actual USB device being emulated, for example, may behave very differently in the real world under unusual or unanticipated circumstances. Thus, the proposed device can only ensure compliance with the emulation, not with the real-world USB device.

### SUMMARY OF THE INVENTION

There is an unmet need for, and it would be highly useful to have, an apparatus, system and a method for testing USB host solutions according to the USB specification, which provides for interactions with USB devices determined in a working environment.

The present invention overcomes these drawbacks of the background art by providing an apparatus, system and method for testing USB host solutions according to the USB specification, which provides for interactions with USB devices determined in a working environment. The apparatus preferably comprises hardware for a standard USB device interface and a plurality of instructions for such interactions.

The term “USB host solution” preferably includes a software and hardware combination for providing USB host functionality, wherein such host functionality is as defined by the relevant USB specifications and associated standards and specifications.

The term “USB device hardware interface” preferably includes a physical entity that responds to low level bus requests.

At least some of these interactions are optionally and preferably determined according to standard commands of the USB specification, for example those in chapter 9 of the USB 2.0 specification (referred to hereinafter as the “standard commands”).

Other interactions are preferably obtained by analyzing the behavior of actual USB devices in the working environment and more preferably recording both inputs given to the USB devices and reactions to such inputs, resulting in outputs from the USB devices. The combination of the inputs and outputs most preferably comprises the behavior of each such USB device in the “real world” working environment.

According to some embodiments, a system is provided which preferably includes the above components, although optionally the components may be separate.

According to other embodiments, a method according to the present invention includes obtaining information about real-world working environment behavior of at least one USB device; simulating the behavior of the at least one USB device to a USB host solution; and determining a reaction of the USB host solution to such behavior. As determined by the USB specification, the USB host solution always initiates interactions with the USB devices.

According to some embodiments of the present invention, there is provided an apparatus, which comprises a computer, comprising a USB device hardware interface. The apparatus preferably also comprises instructions, for example optionally implemented in software, and a database describing the behavior of many, even thousands, of real-world USB devices. The instructions preferably enable the information from the database to be used to simulate the specific, actual, “real world” behavior of the devices, more preferably including both outputs and reactions to inputs. The database also preferably includes parameters and information for determining compliance of the USB host solution with the USB specification, for example by testing for compliance with the standard commands.

The USB host solution is connected to the USB device hardware interface, either directly or optionally through a hub. As the instructions are executed, each USB device hardware interface simulates a USB device or optionally devices, whether according to the standard commands alone or also according to the recorded behavior of actual USB devices in a working environment. For example, the USB host solution treats the USB device hardware interface as though it were a standard USB device, and receives data according to one or more of the standard commands and/or the recorded behavior in the database.

The reactions of the USB host solution are then optionally and preferably determined, and more preferably are analyzed. For example, the reactions may optionally be compared to the expected reactions with regard to compatibility with the USB specification. In case of recorded behavior, particularly known errors and/or non-compliant responses generated by actual USB devices, the reactions of the USB host solution are preferably analyzed with regard to the ability to handle such non-standard behavior.

Optionally, the reactions are not analyzed. Instead, a test or a group of tests may optionally be performed to determine whether the USB host solution remains functional after the test or series of tests, for example.

According to embodiments of the present invention, different configurations of USB devices are preferably tested, including but not limited to different device combinations, multi configuration devices, communication with or without a hub and so forth. Such testing preferably includes compliance testing, to ascertain whether the USB host solution behaves consistently according to the standard commands.

Testing for specific types of real-world devices is also preferably performed. For example, if the behavior of a storage device that is USB compatible, such as a thumb drive for example, is to be examined with regard to interactions with the USB host solution, then such behavior of the storage device is preferably recorded while performing real-world activities such as format, read/write activities, etc. The USB host solution is then preferably tested according to the ability to invoke such real-world activities while correctly responding to the actual recorded responses of the storage device.

The apparatus also preferably comprises a test agent for enabling one or more tests to be administered externally, for example by enabling the user to enter one or more parameters for such tests manually, and/or for enabling tests to be implemented and uploaded automatically.

A user may optionally view at least the analyzed results, and preferably is able also to view the various inputs and outputs to and from the simulated USB device(s). For example, the apparatus or system of the present invention may optionally and preferably comprise a display and a user interface through which one or more commands may be entered by the user and also for displaying the above analyzed results and other information. The user interface preferably includes a GUI (graphical user interface) through which the user can interact with the test agent, for example to construct tests, upload tests and/or review one or more reports regarding executed tests.

Alternatively or additionally, the apparatus of the present invention may optionally communicate with one or more other computers through a computer network. The user interface and display may then optionally be provided through the one or more other computers of the network. Optionally, the user interface may comprise software capable of displaying mark-up language documents, such as web pages, such that the device according to the present invention may optionally communicate with an external computer according to HTTP (HyperText Transfer Protocol) or any other suitable communication protocol. The test results may optionally also be sent by email, SMS or other cellular telephone messaging protocols, facsimile and so forth, or according to any other communication protocol, additionally or alternatively.

The term “working environment” refers to the actual interactions of any USB capable entities, preferably including without limitation USB devices, hubs, host controller, USB host solutions and computers, as implemented for actual use.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, any type of mobile communication device, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

By “online”, it is meant that communication is performed through an electronic communication medium, including but not limited to, telephone voice communication through the PSTN (public switched telephone network), cellular telephones or a combination thereof, data communication according to any type of wireless communication protocol, including but not limited to SMS, MMS, EMS and the like; exchanging information through Web pages according to HTTP or any other protocol for communication with and through mark-up language documents; exchanging messages through e-mail (electronic mail), messaging services such as ICQ for example, and any other type of messaging service; any type of communication using a computational device as previously defined; as well as any other type of communication which incorporates an electronic medium for transmission.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary, illustrative system according to the present invention; and

FIG. 2 shows other aspects of FIG. 1 in more detail, in an exemplary, non-limiting, illustrative implementation.

### DETAILED DESCRIPTION OF THE INVENTION

The present invention is of an apparatus, system and method for testing USB host solutions according to the USB specification, which provides for interactions with simulated USB devices determined in a working environment.

According to some embodiments of the present invention, the apparatus preferably comprises a computer, comprising at least one, and more preferably a plurality of, USB device hardware interfaces.

The apparatus preferably also comprises instructions, for example optionally implemented in software, and a database describing the behavior of many, even thousands, of real-world USB devices. The instructions preferably enable the information from the database to be used to simulate the specific, actual, “real world” behavior of the devices, more preferably including both outputs and reactions to inputs. The database also preferably includes parameters and information for determining compliance of the USB host solution with the USB specification, for example by testing for compliance with the standard commands in Chapter 9 of the USB specification (referred to hereinafter as the “standard commands”).

The USB host solution is connected to the USB device hardware interface, either directly or optionally through a hub or any other USB compatible interface. As the instructions are executed, each USB device hardware interface simulates one or more USB devices, whether according to the standard commands alone or also according to the recorded behavior of actual USB devices in a working environment, preferably including device anomalies. For example, the USB host solution communicates with the USB device hardware interface as though it were an actual USB device, and receives data according to one or more of the standard commands and/or the recorded behavior in the database.

The reactions of USB host solution are then optionally and preferably determined, and more preferably are analyzed. For example, the reactions may optionally be compared to the expected reactions with regard to compatibility with the USB specification. In case of recorded behavior, particularly known errors and/or non-compliant responses generated by actual USB devices, the reactions of the USB host solution are preferably analyzed with regard to the ability to handle such non-standard behavior.

Optionally, the reactions are not analyzed. Instead, a test or a group of tests may optionally be performed to determine whether the USB host solution remains functional after the test or series of tests, for example.

According to embodiments of the present invention, different configurations of USB devices are preferably tested, including but not limited to different device combinations, multi configuration devices, communication with or without a hub, optionally including a complex USB topology, and so forth. Such testing preferably includes compliance testing, to ascertain whether the USB host solution behaves consistently according to the standard commands.

Testing for specific types of real-world devices is also preferably performed. For example, if the behavior of a storage device that is USB compatible, such as a thumb drive for example, is to be examined with regard to interactions with the USB host solution, then such behavior of the storage device is preferably recorded while performing real-word activities such as format, read/write activities, etc. The USB host solution is then preferably tested according to the ability to invoke such real-world activities while correctly responding to the actual recorded responses of the storage device.

The apparatus also preferably comprises a test agent for enabling one or more tests to be administered externally, for example by enabling the user to enter one or more parameters for such tests manually, and/or for enabling tests to be implemented and uploaded automatically.

According to other embodiments, a method according to the present invention includes obtaining information about real-world working environment behavior of at least one USB device; simulating the behavior of the at least one USB device to a USB host solution; and determining a reaction of the USB host solution to such behavior.

The database preferably includes information that is necessary for testing compliance with the standard USB commands.

The database also preferably includes a plurality of parameters for simulating the behavior of each USB device to the USB host solution. Creating the parameters for simulating each such device is preferably performed by using, for example, bus analyzers and/or the host stack of Jungo® for parsing traffic and responses, comparing traffic to standards, and measuring timing parameters. The bus analyzer allows all of the USB traffic to be viewed and recorded while an actual USB device is operating in a real-world environment, showing all commands with the exact timing of each command, and indicating errors when the USB device fails to respond correctly to a command. The bus analyzer is a combined hardware and software product that may be purchased “off the shelf”, for example from Lecroy or Ellisys. The USB device is connected through the bus analyzer to any USB host, which invokes various types of behavior on the device. For example, for HID (human interface device) class USB devices such as a keyboard, different people may interact in different ways. The bus analyzer allows one or more persons to interact on the keyboard by typing information, performing menu entries through the keyboard, and so forth. This behavior is then recorded by the bus analyzer and stored in the database for use as part of the simulation of such a device to the USB host solution.

The parameters preferably also include one or more USB descriptors, and more preferably combinations of descriptors, for example preferably including the descriptors featured in chapter 9 of the USB specification or any ECN (Engineering Change Notice) added to it. For the present invention, preferably one or more, and more preferably all, such descriptors are provided. For example, for simulation of actual USB devices, the exact descriptors are provided for each such device. For testing compliancy, a plurality of different combinations of descriptors are created, as allowed by the USB specification.

The response of the USB host solution is then preferably reported, and is more preferably analyzed according to one or more expected responses from the design specification and/or a required response according to the USB specification, although as previously described, optionally no such responses are individually reported; instead the functionality of the USB host solution at the end of the test or tests is preferably determined. As previously described, such responses are optionally and preferably collected by the test agent that is administering the test(s).

The database may also optionally relate to the behavior of USB devices recorded under different operating systems. For example, the database preferably includes recorded behavior of USB devices while operating under the Windows® operating system (Microsoft Corp, USA) as this operating system is one of the most common operating systems available, although of course the behavior under other operating systems could be recorded as well, such as the operating system of Apple Computers, the Linux operating system and so forth.

For example, preferably the behavior of at least USB devices in the category of HID is recorded for simulation. The database preferably includes one or more HID sequences to be played to the USB host solution, including but not limited to one or more sequences from keyboard, mouse, joystick, gamepad and/or other such peripherals. For mass storage devices, preferably such devices having several different sizes and timing issues (for read/write activities) are tested. Of course other classes and types of USB devices could also optionally, alternatively or additionally, be so simulated.

In some cases, a USB device that is composite may therefore also have multiple interfaces for each such function. Such interfaces may be grouped together as defined in the USB 2.0 ECN Interface Association Descriptor (IAD) standard. The database preferably contains one or more parameters relating to such IADs and multiple interfaces, which may be used for testing the USB host solution. Again, preferably the database includes information for testing compliance with such multiple interfaces, as well as recorded behavior of actual USB devices with multiple interfaces while operating in a working environment.

Combinations of different USB devices are also possible and may also preferably be tested through recording and storing the relevant parameters in the database.

According to some embodiments of the present invention, the USB host solution comprises a host plug-in for communicating with the test agent. Optionally and preferably, a skeletal host plug-in is provided, so that the user only has to add the transport for operability with the USB host solution.

The principles and operation of the present invention may be better understood with reference to the drawings and the accompanying description.

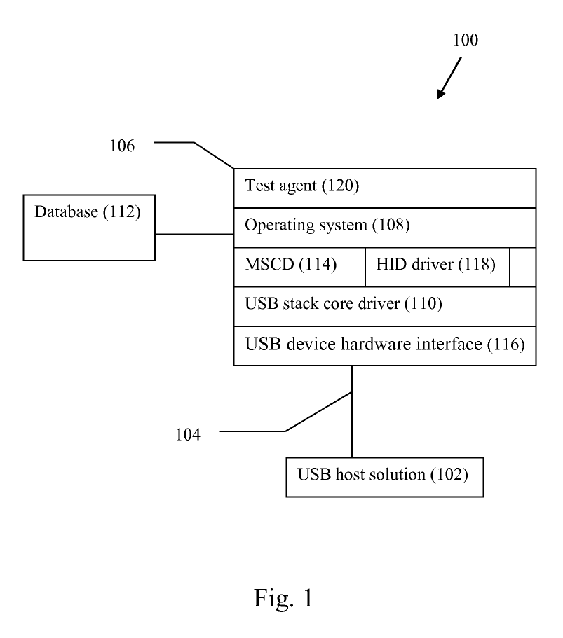

Referring now to the drawings, FIG. 1 shows a schematic block diagram of an exemplary, illustrative system according to the present invention. As shown, a system 100 preferably features a USB host solution 102 that is being tested. USB host solution 102 is connected to a test apparatus 106 according to the present invention, optionally through any type of communication connection 104 such as a hub for example.

Test apparatus 106 is preferably implemented as a stand-alone functional apparatus, for example optionally as a computer with an operating system 108. For the purpose of description only and without intending to be limiting in any way, FIG. 1 is shown with regard to the implementation for a computer. Also the implementation shown in FIG. 1 is intended only as a non-limiting example. Test apparatus 106 preferably comprises at least one USB device hardware interface 116, a USB stack core driver 110 and a plurality of class drivers, of which non-limiting examples include a mass storage class driver (MSCD) 114 and a HID driver 118 as shown. Each USB device hardware interface 116 is preferably able to flexibly represent a different USB device or devices for interacting with USB host solution 102.

Optionally and preferably, at least the inputs are obtained from a database 112. As previously described, some inputs are preferably determined according to standard USB commands (for determining compliance of USB host solution 102), while other inputs are preferably recorded according to the actual behavior of real-world USB devices in a working environment. The inputs are preferably then executed through USB device hardware interface 116 according to one or more instructions.

For example, with regard to determining compliance, preferably inputs are used to induce interactions between USB stack core driver 110 and USB host solution 102. One or more class drivers, such as the non-limiting examples of MSCD 114 and/or HID driver 118, are used for simulating USB devices with the recorded inputs regarding actual behavior of real-world USB devices for interacting with USB host solution 102.

For multi-configuration USB devices, preferably all possible configurations are simulated according to different use cases permitted by the USB specification. Simulation is preferably also supported for multiple-interface devices or single-interface devices.

The use cases of embedded host and OTG (on the go), etc, are preferably also supported and tested.

In order to manage the different tests and also optionally to permit a user to enter one or more tests, a test agent 120 is preferably provided. Test agent 120 enables the user to build tests manually and/or to enter such tests automatically. Test agent 120 also optionally and preferably enables reports to be provided regarding the behavior of USB host solution 102.

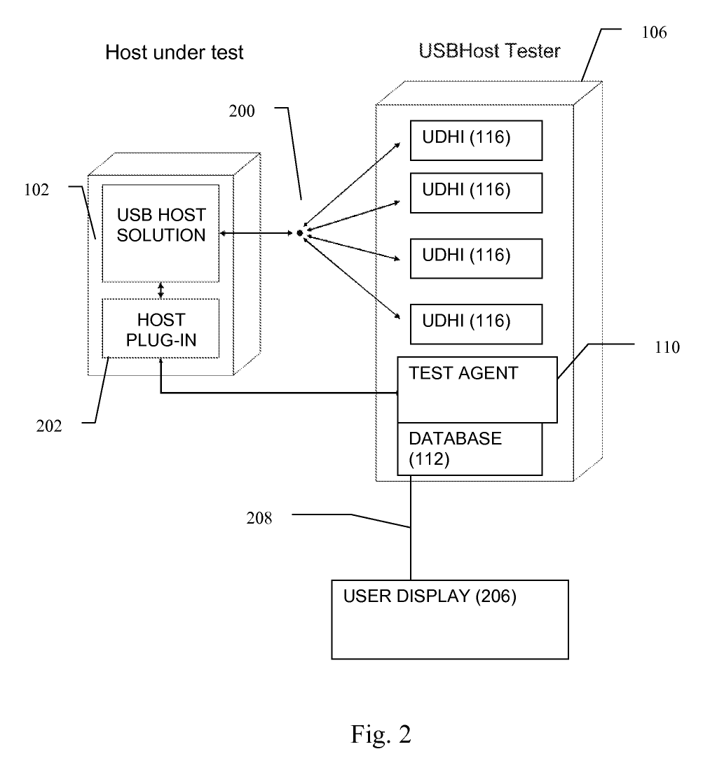

FIG. 2 shows other aspects of the exemplary, non-limiting, illustrative implementation of FIG. 1 in more detail. As shown, USB host solution 102 again communicates with test apparatus 106, through a hub 200. Test apparatus 106, which is preferably configured as a computer (for example as a PC), features database 112, a plurality of different USB device hardware interfaces (UDHI) 116 and test agent 120, which operate substantially as previously described.

A host plug-in 202 is preferably provided for enabling reporting to test agent 120 and also optionally providing inputs directly from test agent 120 to host plug-in 202, for example preferably for compliance testing with the standard commands. Test agent 120 also preferably runs the previously described tests with information from database 112 and prepares a report.

The report, optionally with other information, is then preferably output to a user display 206, which may for example optionally include an external computer and/or a monitor, for displaying information to the user. User display 206 is also optionally able to accept one or more inputs from the user, for example for input commands and/or to view various types of information. User display 206 may also optionally be present on a remote computer, for example through a network connection 208 as shown.

While the invention has been described with respect to a limited number of embodiments, it will be appreciated that many variations, modifications and other applications of the invention may be made.

What is claimed is:

1. Apparatus for testing a USB host solution according to the USB specification, comprising:
at least one USB device hardware interface for being connected to the USB host solution;
a plurality of parameters relating to behavior of said plurality of USB devices in a working environment; and
a plurality of instructions for simulating said behavior according to said parameters through said at least one USB device hardware interface to the USB host solution.

2. The apparatus of claim 1, implemented as a computer, wherein said at least one USB device hardware interface comprises a plurality of USB device hardware interfaces, each simulating a different USB device or devices.

3. The apparatus of claim 2, for providing inputs related to behavior of said USB device as recorded in a working environment.

4. The apparatus of claim 1, further comprising a test agent for managing the tests.

5. The apparatus of claim 4, wherein said test agent manages a plurality of tests automatically.

6. The apparatus of claim 5, wherein said test agent manages said tests in an end-to-end testing solution.

7. The apparatus of claims 1, further comprising a database of a plurality of different abnormal and/or normal behaviors of said plurality of USB devices in said working environment.

8. A system for testing a USB host solution according to the USB specification, comprising the apparatus of claim 1 and further comprising a user display for displaying information regarding said execution, said behavior and/or said response.

9. A method for testing a USB host solution according to the USB specification, comprising:
recording behavior of a plurality of USB devices in a working environment; and
simulating said behavior to the USB host solution.
